(19) United States
(12) Patent Application Publication
(10) Pub. No.: US 2025/0302223 A1
(43) Pub. Date: Oct. 2, 2025

(54) PACKAGE LOCKER FOR PACKAGES CARRIED BY UNMANNED AERIAL VEHICLES

(71) Applicant: Express Scripts Strategic Development, Inc., St. Louis, MO (US)

(72) Inventors: John Ciliberti, Sparta, NJ (US); Christopher M. Myers, Dublin, OH (US); Timothy B. Clise, Howell, MI (US)

(21) Appl. No.: 18/621,424

(22) Filed: Mar. 29, 2024

(51) Int. Cl. A47G 29/14; A47G 29/30; B64U 20/80; B64U 101/64; E05B 65/02

(52) U.S. Cl. CPC A47G 29/141; A47G 29/30; E05B 65/025; A47G 2029/143; A47G 2029/149; B64U 20/80; B64U 2101/64

(57) ABSTRACT

A package locker moves packages vertically and/or horizontally to different locker compartments to create additional space at the top to receive additional packages. The packages may be delivered by an unmanned aerial vehicle. The package locker includes a locker bay including a first locker compartment and a second locker compartment. The first locker compartment overlies the second locker compartment. The first and second locker compartments each having an interior sized and shaped to hold a package. The first locker compartment includes a floor. The floor is arrangeable in a first position where the floor is arranged to support the package in the interior of the first locker compartment and in a second position where the floor is arranged to permit the package to fall, under the influence of gravity, from the interior of the first locker compartment into the interior of the second locker compartment.

### FIELD

The present disclosure generally relates to package delivery systems, and more particularly to a package locker useable with unmanned aerial vehicles (UAVs) to deliver packages to consumers.

### BACKGROUND

Packages are used to deliver items throughout the world. One such item frequently delivered in packages to consumers are pharmaceutical containers containing pharmaceuticals. Conventionally, these packages are delivered to businesses and residences using land-based vehicles, such as trucks, but the development of aerial based delivery vehicles, such as drones, unmanned aerial vehicles (UAVs), etc., has opened up other delivery methods.

### SUMMARY

In one aspect, a package locker comprises a locker bay including a first locker compartment and a second locker compartment. The first locker compartment overlies the second locker compartment. The first and second locker compartments each having an interior volume, defined by walls, sized and shaped to hold a package. The first locker compartment includes a floor. The floor is arrangeable in a first position where the floor is arranged to support the package in the interior of the first locker compartment and in a second position where the floor is arranged to permit the package to fall, under the influence of gravity, from the interior of the first locker compartment into the interior of the second locker compartment. In an example, the systems can also use a configuration of the floor and walls to allow gravity to move a package from a higher locker compartment to a lower locker compartment.

In another aspect, a package locker comprises a first locker compartment having an interior volume sized and shaped to hold a package. A second locker compartment underlies the first locker compartment. The second locker compartment has an interior sized and shaped to hold the package. A third locker compartment has an interior sized and shaped to hold the package. The third locker compartment is disposed side-by-side with the second locker compartment such that the interior of the third locker compartment is horizontally and vertically offset from the interior of the first locker compartment. A package mover is configured to move the package from the interior of the first locker compartment to the interior of the third locker compartment.

In another aspect, a package locker comprises a locker compartment having an interior sized and shaped to hold a package. The locker compartment includes an access door at the front of the locker compartment. The access door is moveable between a closed position where access door inhibits consumer access to the interior of the locker compartment and an open position where the access door permits consumer access to the interior of the locker compartment to allow a consumer to remove the package. A storage compartment has an interior volume sized and shaped to hold the package. The storage compartment is disposed rearward of the locker compartment. A dividing wall is arrangeable in a first configuration where the dividing wall separates the interiors of the locker compartment and the storage compartment and in a second configuration where the dividing wall permits the package to move from the interior of the storage compartment to the interior of the locker compartment.

Other objects and features of the present disclosure will be in part apparent and in part pointed out herein.

### BRIEF DESCRIPTION OF THE DRAWINGS

FIG. 1 is a schematic diagram of a UAV;

FIG. 2 is a schematic diagram of a control device for the UAV;

FIG. 3 is a schematic diagram of a package delivery system;

FIG. 4 is a perspective of a package locker according to one embodiment of the present disclosure;

FIG. 5 is a section of the package locker of FIG. 4;

FIG. 6 is a fragmentary section of a package locker according to another embodiment of the present disclosure;

FIG. 7 is a fragmentary section of a package locker according to another embodiment of the present disclosure;

FIG. 8 is a section of a package locker according to another embodiment of the present disclosure;

FIG. 9 is a fragmentary section of a package locker according to another embodiment of the present disclosure;

FIG. 10 is a fragmentary section of a package locker according to another embodiment of the present disclosure;

FIG. 11 is a fragmentary section of a package locker according to another embodiment of the present disclosure;

FIG. 12 is a perspective of a package locker according to another embodiment of the present disclosure;

FIG. 13 is a fragmentary section of the package locker of FIG. 14;

FIG. 14 is a fragmentary section of a package locker according to another embodiment of the present disclosure;

FIG. 15 is a front elevation of a package locker according to another embodiment of the present disclosure; and

FIG. 16 is a schematic diagram of a control system for a package locker.

Corresponding reference characters indicate corresponding parts throughout the drawings.

### DETAILED DESCRIPTION

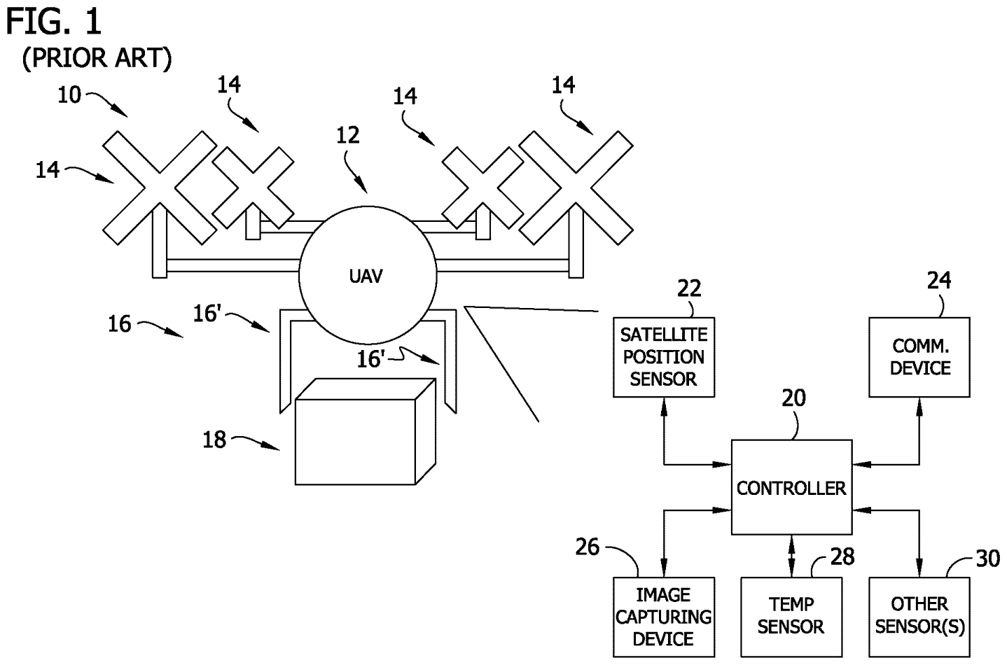

Referring to the drawings, FIGS. 1-3 generally illustrate a package delivery system 200 that delivers packages 18 with UAVs 10 to a delivery destination or location, e.g., to an entry of a locker system. The package delivery system 200 may be used to deliver any type of package 18, such as a package containing one or more pharmaceuticals. Further details on the package delivery system 200 may be found in U.S. Pat. No. 11,513,538, the entirety of which is hereby incorporated by reference.

FIG. 1 generally illustrates a UAV 10 including a body 12 and one or more rotors 14. The UAV includes a carrier 16 disposed on the body 12. The carrier 16 is configured to carrier or hold a package 18, such as a medication package. The carrier 16 includes one or more carrier arms 16′. The carrier arms 16′ are actuatable or articulate arms that selectively grip and release the package 18. UAVs with other types of carriers may be used without departing from the scope of the present disclosure. The UAV 10 includes a controller 20 configured to control operations of the UAV 10. The controller 20 may include a UAV processor and a UAV memory. The UAV processor may include any suitable processor, such as those described herein. The UAV memory may include any suitable memory, such as those described herein. The UAV 10 may include various sensors or data capturing devices. For example, the UAV 10 can include a satellite positioning (e.g., a global positioning system (GPS) sensor) 22 configured to provide global positioning data. The controller 20 may use the global position data received from the satellite positioning sensor 22 to operate the UAV 10 along a delivery path for the package 18, or any suitable path. The UAV 10 may include a communication device 24 (e.g., WiFi, Bluetooth, cellular, satellite, etc.) configured to communicate with, as is generally illustrated in FIGS. 3A and 3B, other UAVs, such as the other UAVs 10′, one or more mobile computing devices, such as the mobile computing device 202, data sources, such as a location specific data source 204 and an environmental characteristics data source 206, a hub station, such as the hub station 210, other suitable devices or mechanism, or a combination thereof. The UAV's communication device 24 can send a beacon signal to identify the UAV and the package being transported by the UAV to the locker system electronic circuitry. The UAV 10 may include an image-capturing device 26 and/or other suitable data capturing devices. The image-capturing device 26 is configured to capture image data and the controller 20 may be configured to analyze the image data and selectively control the UAV 10 based on the image data. The image-capturing device 26 can take an image of a package that is deposited into an entry locker or used to align the UAV with the entry for a package at the locker. The UAV 10 may include a temperature sensor 28. The temperature sensor 28 is configured to sense the temperature of the environment external to the UAV 10. The controller 20 may selectively control operations of the UAV 10 based on the one temperature measurements. The UAV 10 may include other sensors 30. The other sensors 30 may include any suitable sensors include gyroscope sensors, vibration sensors, motion sensors, moisture sensors, light sensors, infrared sensors, radar sensors, LIDAR sensors, sonar sensors, any other suitable sensors, or a combination thereof. These sensors can align the UAV 10 with the entry of a locker.

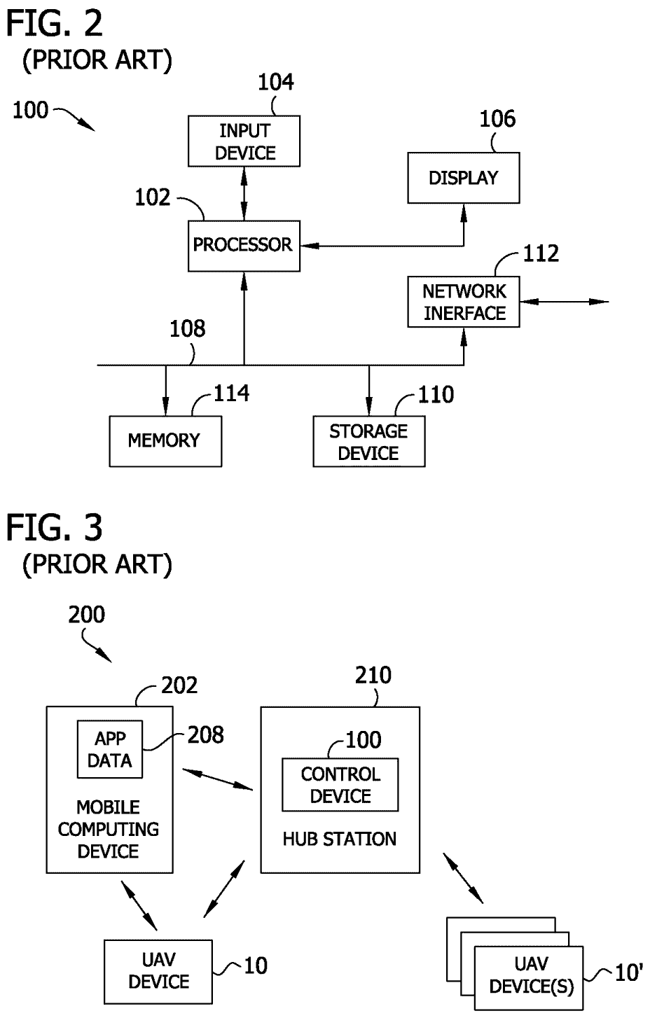

FIG. 2 generally illustrates a control device 100 for the UAV 10. The control device 100 is configured to control operation of the UAV 10 and/or other UAVs 10′. As is generally illustrated, the hub station 210 may include the control device 100. The control device 100 includes a processor 102 configured to control the overall operation of control device. The processor 102 may include any suitable processor, such as those described herein. The control device 100 includes a user input device 104 that is configured to receive input from a user of the control device and to communicate signals representing the input received from the user to the processor 102. For example, the user input device 104 may include a button, keypad, dial, touch screen, audio input interface, visual/image capture input interface, input in the form of sensor data, etc. The control device 100 includes a display 106 that may be controlled by the processor 102 to display information to the user. A data bus 108 facilitates data transfer between, at least, a storage device 110 and the processor 102. The storage device 110 may be any suitable memory, such as those described herein. The control device 100 may also include a network interface 112 configured to couple or connect the control device to various other computing devices or network devices via a network connection, such as a wired or wireless connection. The control device 100 may also include a memory 114, such as those described herein. The processor 102 is configured to execute instructions stored on the memory 114 to, at least, control operations of the UAV 10, the other UAVs 10′, delivery of the package 18, any other suitable operations, or a combination thereof.

FIG. 3 generally illustrates a block diagram of the package delivery system 200, including the UAV 10, the other UAVs 10′, and the hub station 210. The control device 100 of the hub station 210 may provide instructions to the UAV 10 to deliver the package 18, retrieve the package 18, other suitable instructions, or a combination thereof. The UAV 10 may autonomously carry out the instructions. For example, the control device 100 may instruct the UAV 10 to transport the package 18 to a delivery destination and the UAV may autonomously determine a flight path to the delivery destination and/or autonomously determine or execute various other operations. In some embodiments, the hub station 210 may be housed or located at a pharmacy, at a distribution center, at a delivery center, on a vehicle (e.g., a mobile distribution center), and the like. In some embodiments, the package 18 may be packed at a pharmacy, distribution center, or other suitable location.

The hub station 210 (e.g., via the control device 100) can selectively control delivery of the package 18 using the UAV 10 and/or the other UAVs 10′. The UAV 10 and the other UAVs 10′ may communicate directly with the control device 100. The control device 100 receives instructions indicating that the package 18 is ready for delivery. The control device 100 can receive the instructions from a corresponding pharmacy or any suitable source. The instructions indicate a delivery destination or location for the package 18, e.g., a locker. The package 18 may be transported to the hub station 210 or the hub station 210 may be located at the pharmacy or other suitable location where the package 18 is packed.

The control device 100 may communicate with a mobile computing device 202. The mobile computing device 202 may correspond to or be associated with the recipient or consumer of the package 18. The mobile computing device 202 may include any suitable mobile computing device, such as a smart phone, a tablet-computing device, and the like. The mobile computing device 202 may include various application data 208. The application data 208 include data from various applications on the mobile computing device 202. For example, the application data 208 may include calendar data, global position (e.g., satellite position data) data or other location data, other suitable data, or a combination thereof. The control device 100 may receive the application data 208 from the mobile computing device 202. The control device 100 may determine or estimate a probability that the recipient will retrieve the package 18 during a period based on the application data 208. For example, the control device 100 may analyze various calendar data and determine a probability, based on various events, calendar appointments tasks, and the like, that the recipient will be at or near the delivery destination within the period. Additionally, or alternatively, the recipient may indicate a delivery period via the mobile computing device 202. Additionally, or alternatively, the control device 100 may determine a current location of the mobile computing device 202 based on the satellite positioning data or other location data, and may determine a probability that the recipient will be at or near the delivery destination during the period. Other data, such as user provided input, can be used by the control device 100 to determine a current location of the mobile computing device 202. Additionally, or alternatively, the control device 100 may receive, from the mobile computing device 202, an indication that the package 18 has been retrieved. For example, the recipient may interact with an application 208 on the mobile computing device 202 to indicate that the recipient has retrieved the package 18.

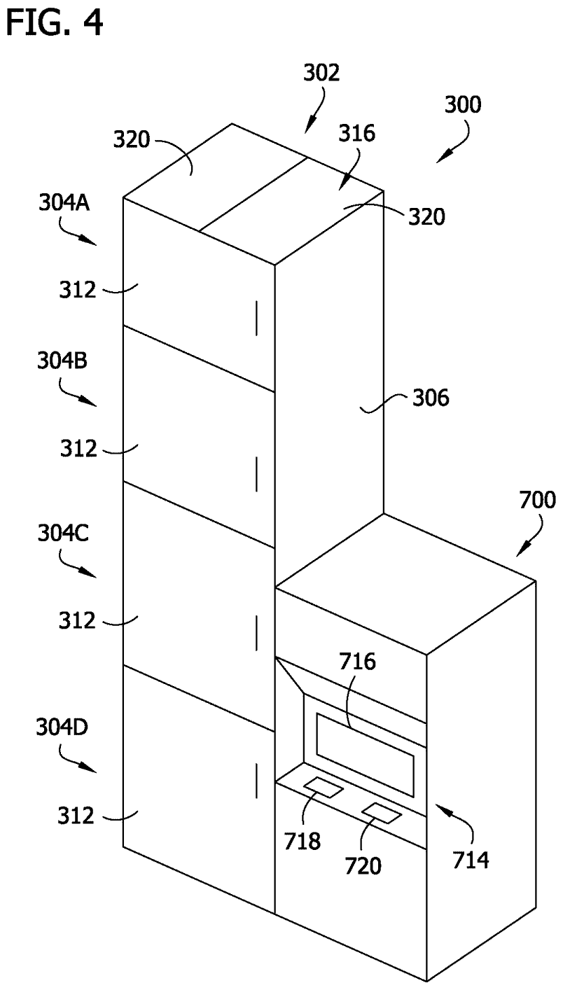

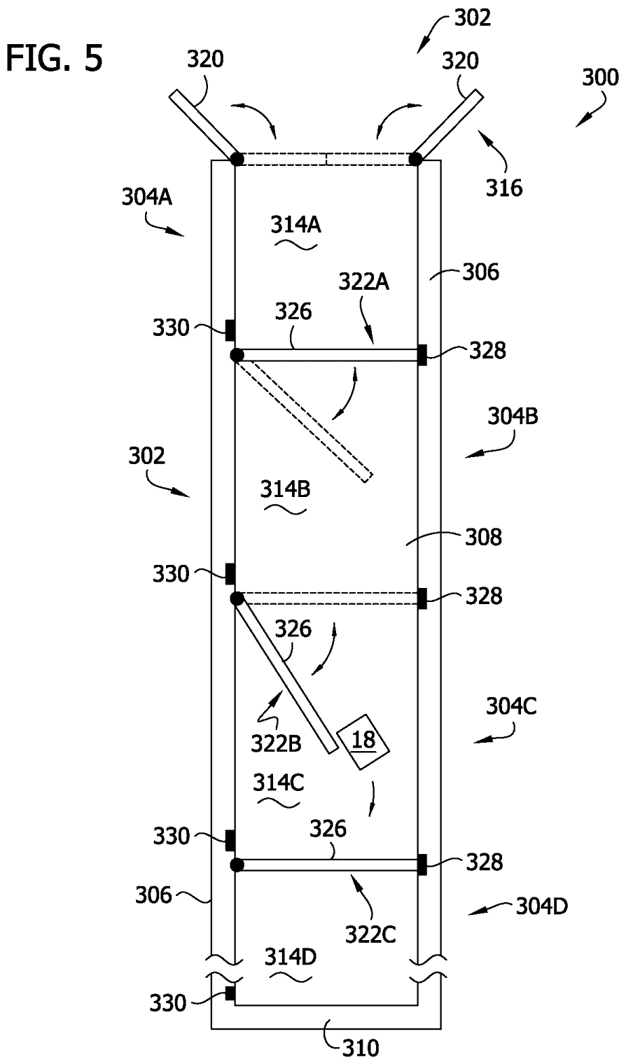

Referring to FIGS. 4 and 5, one embodiment of a package locker or vault (e.g., container vault) according to the present disclosure is generally indicated by reference numeral 300. The package locker 300 may be part of the package delivery system 200. For example, the package locker 300 may be the delivery destination to which the UAV 10 delivers the package 18. Additionally, or alternatively, the package locker 300 may be the hub station 210 of the package delivery system 200. The package locker 300 receives the package 18 from the UAV 10 and stores the package until the recipient of the package comes to the package locker to pick up the package. The package locker 300 is able to hold many packages, with generally each package belonging to a different recipient. The package locker 300 can be deployed as a standalone unit. The package locker 300 can be installed in a facility such as a retailer, community center, medical facility, pharmacy, etc. If installed in a facility, the facility may include a UAV opening in an exterior wall to allow the UAV's to fly into and out of the facility to reach the package locker 300. The UAV opening may also be a door or window that is opened automatically upon arrival of the UAV at the facility or within a certain distance from the door or window. The UAV or its controlling circuitry can send an identification signal or open signal to the facility circuitry, which then opens the UAV opening to allow the UAV to fly into the facility and approach the package locker.

The package locker 300 includes a locker bay 302. The illustrated package locker 300 includes one locker bay 302, although the package locker may include more than one locker bay, as described herein. The locker bay 302 comprises a plurality of locker compartments (e.g., first, second, third, fourth, etc.) 304. The locker compartments are stacked one on top of the other in the locker bay, forming a vertical column of locker compartments. Thus, in general, one locker compartment 304 overlies another locker compartment (or, in other words, one locker compartment underlies another locker compartment in a stacked arrangement). In the illustrated embodiment (FIG. 4), the locker bay 302 includes four locker compartments 304 (designated as 304A-D), although more of fewer locker compartments 304 may be employed without departing from the scope of the present disclosure. As used herein and in the drawings, when a reference character includes a reference numeral not followed by a letter, such a reference character refers to all elements designated at least in part by the reference numeral. Moreover, when a reference character includes the reference numeral followed by a letter, such as “A,” such a reference character refers to a particular element from the group of elements. For example, as used herein and in the drawings, the reference character “304” refers to all the locker compartments (e.g., 304A-D) designated at least in part with reference numeral “304” and the reference character “304A” refers to a specific one of the locker compartments (in this case the top locker compartment of the locker bay 302 in FIGS. 4 and 5). In an example, the locker bay 302 has a height of up to six feet so that a person can access the front facing door to access the interior volume of a respective one of the locker compartments 304.

The locker bay 302 includes opposite side walls 306 forming the side walls of the locker compartments 304, a rear wall 308 forming the rear walls of the locker compartments, and a base 310 forming a floor of the bottom locker compartment 304D. Each locker compartment 304 includes an interior 314 sized and shaped to hold a package 18. The package 18 may have generally any size and shaped. In one embodiment, the package 18 may be a box (e.g., have a hexahedron shape) such as 6 in ×6 in ×6 in box. In other embodiments, the package 18 may be an envelope or bag. Other types of packages or containers can be used without departing from the scope of the present disclosure. Each locker compartment 304 includes an access door 312 at the front wall of the locker compartment (opposite the rear wall 308). The access door 312 is moveable between a closed position (FIG. 4) where access door inhibits recipient access to the interior 314 of the locker compartment 304 and an open position where the access door permits recipient access to the interior of the locker compartment to allow a consumer to remove the package. The locker compartment's access door 312 can include a handle 315. The recipient of the package 18 opens the access door 312 to retrieve the package in the interior 314 of the locker compartment 304. Each locker compartment 304 includes a releasable door latch or lock 313 (e.g., electronically operated latch or lock, which can be controlled by electronic circuitry). The door lock 313 is arranged to secure the door 312 in the closed position, to inhibit the door from being moved toward the open position (broadly, lock the locker compartment).

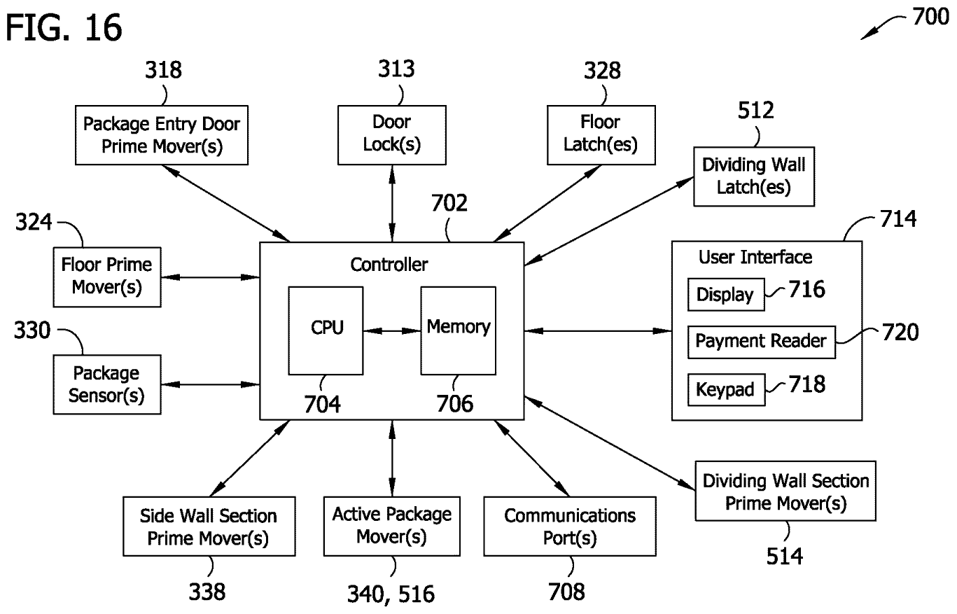

The locker bay 302 (broadly, the package locker 300) is able to receive the package 18 from the UAV 10 and move the package to any locker compartment 304 in the locker bay. To receive the package 18 from the UAV 10, the top locker compartment 304A in the locker bay 302 includes a package entry door 316. The package entry door 316 is at the top of the interior 314 of the top locker compartment 304A (e.g., bounds the top of the interior). The package entry door 316 is arrangeable in (e.g., moveable to) a closed position (FIG. 4) where package entry door inhibits access to the interior 314 of the top locker compartment 304A and in an open position (FIG. 5) where the package entry door is arranged to permit the package 18 to fall, under the influence of gravity, into the interior of the top locker compartment, when the package 18 is released by the carrier 16 of the UAV 10. The package locker 300 includes a prime mover (e.g., a package entry door prime mover) 318 (FIG. 16) operatively connected to the package entry door 316. The package entry door prime mover 318 moves the package entry door 316 between the open and closed positions. The package entry door prime mover 318 may comprise a motor (e.g., electric or pneumatic motor), linear actuator (e.g., electric or pneumatic linear actuator), or any other suitable device. In the illustrated embodiment, the package entry door 316 comprises first and second bomb-bay doors 320. Each bomb-bay door 320 rotates or pivots about a hinge (broadly, pivot connection). The bomb-bay doors 320 are arranged to pivot upward when the package entry door prime mover 318 moves the package entry door 316 toward the open position. In the open position (FIG. 5), the bomb-bay doors 320 are disposed at an angle to the horizontal and vertical, thereby acting as a funnel that guides the package 18 into the interior 304 of the top locker compartment 304A, when the package is dropped by the UAV 10. In an example, the top doors 320 include interlocking fingers that overlap each other to secure the free sides of the doors together. Other types of package entry doors may be used without departing from the scope of the present disclosure.

Each locker compartment 304 includes a floor 322 (the base 310 forms the floor of the bottom locker compartment 304D). To move the package 18 downward to a lower locker compartments 304, each floor 322 (e.g., moveable floor) of the locker compartments (except for the bottom locker compartment 304D) is arrangeable in a first or support position or configuration where the floor is arranged to support the package 18 in the interior 314 of the locker compartment and in a second or release position or configuration where the floor is arranged to permit the package to fall, under the influence of gravity, from the interior of the locker compartment into the interior of the underlying locker compartment. In an example, the bottom most locker compartment has a fixed floor that does not move to a release position. But remains fixed in the support position. For example, in FIG. 5, the first and third floors 322A, 322C are shown in the support position and the second floor 322B is shown in the release position, which permits the package 18 to fall from the interior 314B of the second locker compartment 304B to the interior 314C of the third locker compartment 304C. Each package locker 304 (except for the bottom package locker 304D) includes a floor prime mover 324 (FIG. 16) operatively connected to the floor 322. The floor prime mover 324 moves the floor 322 between the support and release positions. The floor prime mover 324 may comprise a motor (e.g., electric or pneumatic motor), linear actuator (e.g., electric or pneumatic linear actuator), or any other suitable device.

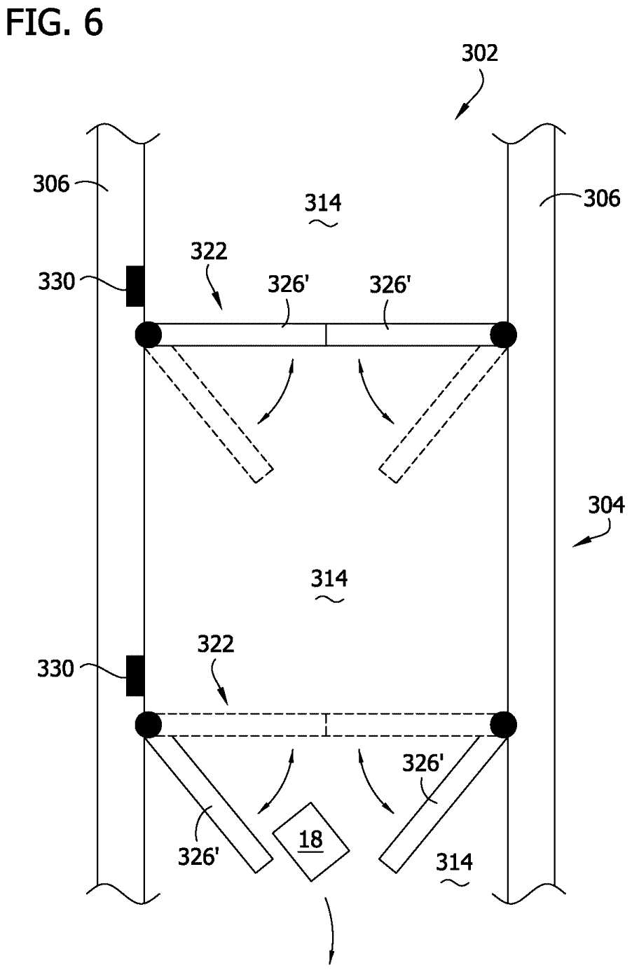

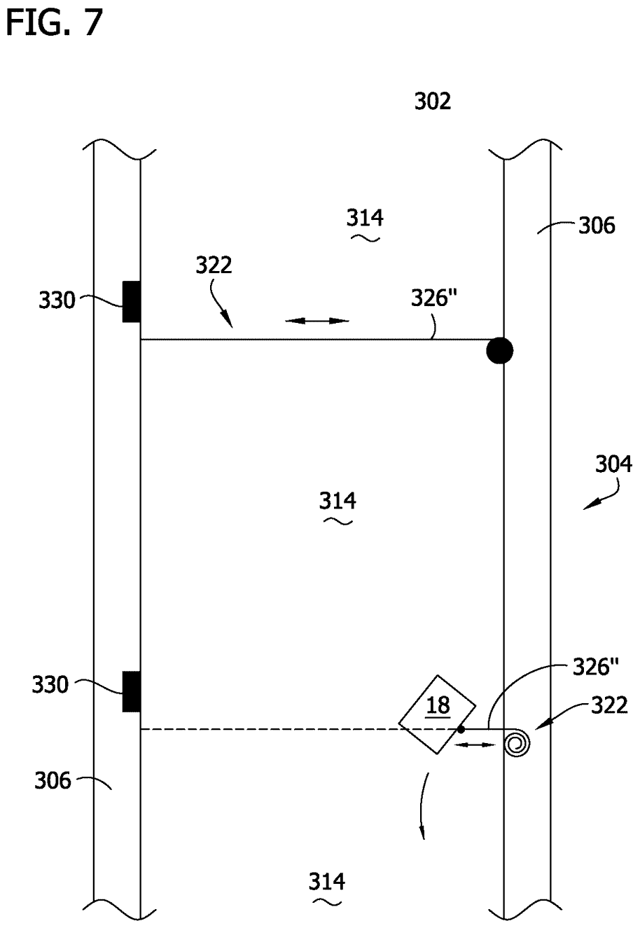

Still referring to FIG. 5, in the illustrated embodiment, the floor 322 comprises a trap door 326. The trap door 326 generally extends the full width of the interior 314 of the locker compartment 304. The trap door 326 pivots about a hinge (broadly, pivot connection). The trap door 326 is arranged to pivot into the interior 314 of the underlying locker compartment 304 when the floor prime mover 324 moves the floor toward the release position. For example, the trap door 326 of the second floor 322B of the second locker compartment 304B is shown pivoted downward into the interior 314 of the third locker compartment 304C. In this embodiment, the height of the interior 314 is greater than the width of the interior to ensure the package 18 falls off of the floor 322 (and onto the underlying floor) while maintaining the necessary clearance to ensure the floor can return to its support position after the package has fallen. Stated another way, the vertical walls defining the interior volume 314 of the locker compartment are taller than the length of floor from its pivot axis. Other configurations of the floor may be used without departing from the scope of the present disclosure. For example, referring to FIG. 6, the floor 322 may comprise first and second bomb-bay doors 326′. Each bomb-bay door 326′ rotates or pivots about a hinge (broadly, pivot connection). The bomb-bay doors 326′ are arranged to pivot downward into the interior 314 of the underlying locker compartment 304 when the floor prime mover 324 moves the floor 322 toward the release position. In another example, referring to FIG. 7, the floor 322 may comprise a roll-up door 326″. The roll-up door 326 may be a fabric or polymer sheet that is rolled up. In another example, the roll-up door 326 can be made of a plurality of slats that are joined together and pivotable along the joint length, which can also be rolled up. The roll-up door 326″ is arranged to be rolled-up when the floor prime mover 324 moves the floor toward the release position. As the roll-up door 326″ is rolled up, the roll-up door 326 generally moves horizontally toward one side of the interior 314. As a result, the package 18 may first move with the roll-up door 326″ and then fall off the roll-up door into the underlying interior 314 when the package contacts the side wall 306 and the roll-up door slides under the package as the roll-up door continues to retract. Likewise, the as the floor prime mover 324 moves the roll-up door back toward the support position, the roll-up door extends horizontally toward the other side of the interior 314. In an example, a drive line, drive belt or drive chain can be connected to the first edge of the roll-up door remote from the roll-up side, such that a prime mover can pull the first edge back across the locker compartment to separate the locker compartment from the lower locker compartment that received the package. In one embodiment, the roll-up door 326″ rolls up into the side wall 306. In these alternative configurations, the height of the interior 314 can be smaller (e.g., equal to or smaller than the width of the interior) because these doors need less (if any) clearance than the trap door 326, thereby allowing more locker compartments in a given space.

As is apparent, by operating the floors 322 a package 18 can be moved to any locker compartment 304 in the locker bay 302. This allows the locker bay 302 to receive the package 18 in the top locker compartment 304A and then move the package to another (e.g., lower) locker compartment 304 in order to receive another package, thereby allowing each locker compartment to contain a package for the package's corresponding recipient.

Referring back to FIG. 5, the locker compartments 304 (except for the bottom locker compartment 304D) may include a releasable floor latch or lock 328 (e.g., electronically operated latch or lock). The floor latch 328 is arranged to secure the floor 322 in the support position, to inhibit the floor from inadvertently moving toward the release position. This also inhibits a recipient of a package 18 in one locker compartment 304 from forcibly moving the floor 322 toward the release position to access the interior 314 of another locker compartment. Although not shown, the floors 322 illustrated in FIGS. 6 and 7 may also include a floor latch. Each locker compartment 304 may also include a package sensor 330. The package sensor 330 is arranged to detect the presence (or absence) of a package in the interior 314 of the corresponding locker compartment 304. This way, the package locker 300 can determine which locker compartments 304 are empty and therefore can have packages moved to them, when a package has dropped from one locker compartment to another locker compartment, and/or when a recipient has received a package from one of the locker compartments. The package sensors 330 may be any suitable sensor, such as a photoelectric sensor or ultrasonic sensor, although other types of sensors may be used without departing from the scope of the present disclosure. For example, in one embodiment the package sensor is an image sensor that captures images (e.g., pictures and/or video) that is then analyzed by package recognition software to determine the presence (or absence) of a package.

In one embodiment, the top locker compartment 304A does not include an access door 312. In this embodiment, the top locker compartment is not accessible to the recipient. Instead, the top locker compartment only receives the package 18 from the UAV 10. This may be desirable for security reasons, as the package entry door 316 may be able to be forced open. In this embodiment, a package 18 is not stored in the top locker compartment 304A. Instead, after a package is received by the top locker compartment 304A, the floor 322A moves to the release position to move the package to the underlying locker compartment 304B. This way a package 18 is not stored in the top locker compartment 304A, where it could be criminally accessed by forcibly opening the package entry door 316. Additionally, or alternatively, the top locker compartment 304A may include a door latch or lock, as described herein, to secure the package entry door in the closed position.

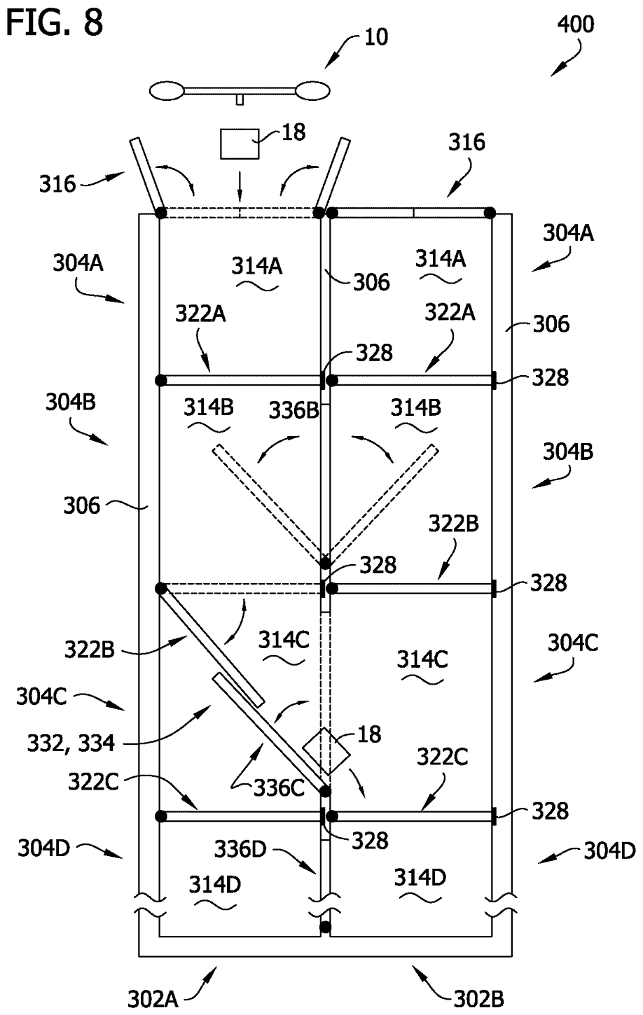

Referring to FIG. 8, another embodiment of a package locker according to the present disclosure is generally indicated by reference numeral 400. The package locker 400 of FIG. 8 is generally analogous to the package locker 300 of FIGS. 4 and 5, and thus, for ease of comprehension, where similar, analogous or identical parts are used, identical reference numerals are employed. Accordingly, unless clearly stated or indicated otherwise, the above descriptions regarding the package locker 300 of FIGS. 4 and 5 also apply to the package locker 400 of FIG. 8.

In this embodiment, the package locker 400 includes two locker bays 302 (broadly, a locker array), with each locker bay including four locker compartments 304. The package locker 400 may include more than two locker bays 302 and each locker bay can include more than four locker compartments 304. In the illustrated embodiment, the top locker compartments 304A of the two lockers bays 302 are disposed side-by-side, the second locker compartments 304B of the two locker bays are disposed side-by-side, and so on. Thus, the interiors 314 of the locker compartments 304 in each locker bay 302 are vertically aligned and the interiors of the locker compartments (e.g., 304B) of each locker bay disposed side-by-side are horizontally aligned. As a result, an interior 314 of one locker compartment 304 in one locker bay 302A is horizontally and vertically offset with respect to other interiors of other locker compartments of the other locker bay 302B. For example, the interior 314B of the second locker compartment 304B of the first locker bay 302A is horizontally and vertically offset from the interior 314C of the third locker compartment 304C of the second locker bay 302B. In this embodiment, the top locker compartment 304A of one or more of the locker bays 302 may not include a package entry door 316.

The two locker bays 306 share a side wall 306 which separates the interiors 314 of the locker compartments. In this embodiment, the side wall 306 includes a plurality of moveable side wall sections or panels 336 (broadly, moveable side walls) which generally separate side-by-side interiors 314. In the illustrated embodiment, each set of side-by-side locker compartments 304 includes a moveable side wall section 336, except for the set of top locker compartments 304A, although in other embodiments the set of top locker compartments may include a moveable side wall section. Each moveable side wall section 336 rotates or pivots about a hinge (broadly, pivot connection). In this embodiment, the hinge is located at the bottom of the side wall section 336. Each moveable side wall section 336 is arrangeable in a first or closed position or configuration where the side wall section separates the interiors 314 of the two side-by-side locker compartments 304 and in a second or open position or configuration where the side wall section permits a package to move through the side wall 306 (e.g., an opening in the side wall 306 vacated by the side wall section). In the open position, the side wall section 336 is disposed in the interior 314 of one locker compartment 304 and underlies the interior of the locker compartment overlying said one locker compartment. Each side wall section 336 is operatively connected to a prime mover 338 (e.g., a side wall section prime mover) (FIG. 16). The side wall section prime mover 338 moves its corresponding side wall section 336 between the open and closed positions. The side wall section prime mover 338 may comprise a motor (e.g., electric or pneumatic motor), linear actuator (e.g., electric or pneumatic linear actuator), or any other suitable device.

In this embodiment, the package locker 400 includes a package mover (broadly, one or more package movers), generally indicated at 332, to move the packages 18 laterally, between locker bays 302. Accordingly, the package mover 332 may be considered as a lateral or side-to-side package mover. The lateral package mover 332 can move a package from one interior 314 of a locker compartment 304 of one of the locker bays 302 to another interior of a locker compartment of the other locker bay that is horizontally and vertically offset from the original interior. For example, as shown in FIG. 8, the lateral package mover 332 can move the package 18 from the interior 314B of the second locker compartment 304B of the first locker bay 302A to the interior 314C of the third locker compartment 304C of the second locker bay 302B. In the illustrated embodiment, the lateral package mover 332 is a passive package mover 334, meaning that the package mover relies on gravity to move the package 18 laterally. The passive package mover 334 is configured to move the package 18 under the influence of gravity from the interior 314 of one locker compartment 304 to the interior of another locker compartment. In the illustrated embodiment, the passive package mover 334 is configured to move the package 18 from the interior 314 of one locker compartment 304 to the interior of another locker compartment solely under the influence of gravity, although passive package movers that use a combination of gravity and other (e.g., active) means to move a package laterally may be used without departing from the scope of the present disclosure.

In the illustrated embodiment, the package locker 400 includes a plurality of lateral package movers 332. Each lateral package mover 332 includes the floor 322 of one of the locker compartments 304 and the moveable side wall section 336. One moveable side wall section 336 may be part of two lateral package movers 332, depending on which floor 322 is being used (as will become apparent). The floor 322 and the side wall section 336 of the lateral package mover 332 are arrangeable in a ramp configuration (see FIG. 8) where the floor overlaps the side wall section 336 such that the floor and side wall form a ramp along which the package 18 can slide, under the influence of gravity, from the interior 314 of one locker compartment 304 in one locker bay 302 to the interior of another locker compartment in another locker bay. For example, as shown in FIG. 8, the floor 322B of the second locker compartment 304B in the first bay and the side wall section 336C separating the interiors 314C of the third locker compartments 304C are shown in the ramp configuration. The floor 322B and the side wall section 336C are disposed at an angle to the horizontal (and the vertical) such that they each form a ramp (e.g., sections of the ramp) along which the package 18 can slide, under the influence of gravity, toward the interior 314C of the third locker compartment 304C of the second locker bay 302B, after or as the package falls from the interior 314B of the second locker compartment 304B of the first locker bay 302A. The floor 322B overlies the side wall section 336C such that the package 18 can slide off the end of the floor and onto the side wall section and continue moving toward the interior 314C. This can be repeated for any floor 322 and side wall section 336 combination. Each side wall section 336 can pivot in both directions to move packages 18 from the first locker bay 302A to the second locker bay 302B or vice versa.

With the combination of the moveable floors 322 and the moveable side wall sections 336 (which are separately operable), the package locker 400 can move a package 18 to the interior 314 of generally any locker compartment 304 of the locker bays 302. For example, a package 18 received by the top locker compartment 304A of the second locker bay 302B can be moved to the interior 314C of the third locker compartment 304C of the first locker bay 302A by (1) arranging the floor 322A of the top locker compartment 304A of the second locker bay 302B and the side wall section 336B between the set of second locker compartments 304B in the ramp configuration to move the package into the interior 314B of the second locker compartment 304B of the first locker bay 302A; and (2) then moving the floor 322B of the second locker compartment 304B of the first locker bay 302A to the release position to allow the package to fall into the interior 314C of the third locker compartment 304C of the first locker bay 302A. With these principles in mind, it is understood the floors 322 and the side wall sections 336 can be operated in generally any sequence to move a package 18 to a desired locker compartment 304.

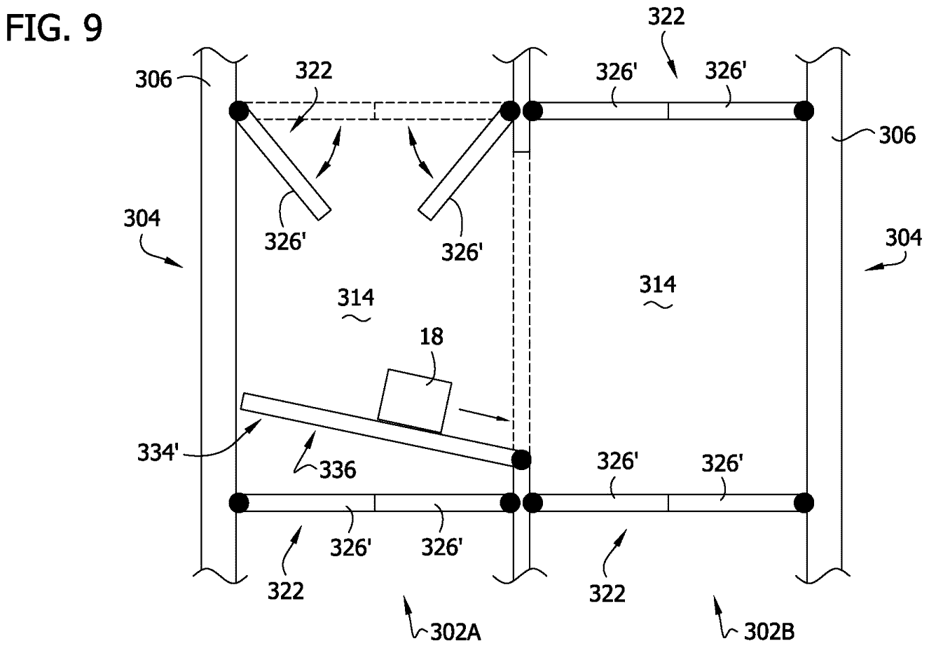

Referring to FIG. 9, an alternative embodiment of the passive package mover 334′ is shown. This passive package mover 334′ includes the bomb-bay doors 326′ of the floor 322 (see FIG. 6). Alternatively, this passive package mover 334′ could include the roll-up door 326″ of the floor 322 (see FIG. 7). In this embodiment, the side wall section 336 generally extends all the way to the other side wall 306 in the open position. As a result, the side wall section 336 generally underlies the entirety of the floor 322. In this embodiment, only the side wall section 336 forms the ramp. When the bomb-bay doors 326′ move to the open position, the package 18 falls down onto the side wall section 336. The package 18 may then slide along the side wall section 336 toward the interior 314 of the locker compartment 304 in the other locker bay 302. If the package stops sliding on the side wall section 336, the package will restart sliding as the side wall section 336 is pivoted back to the closed position.

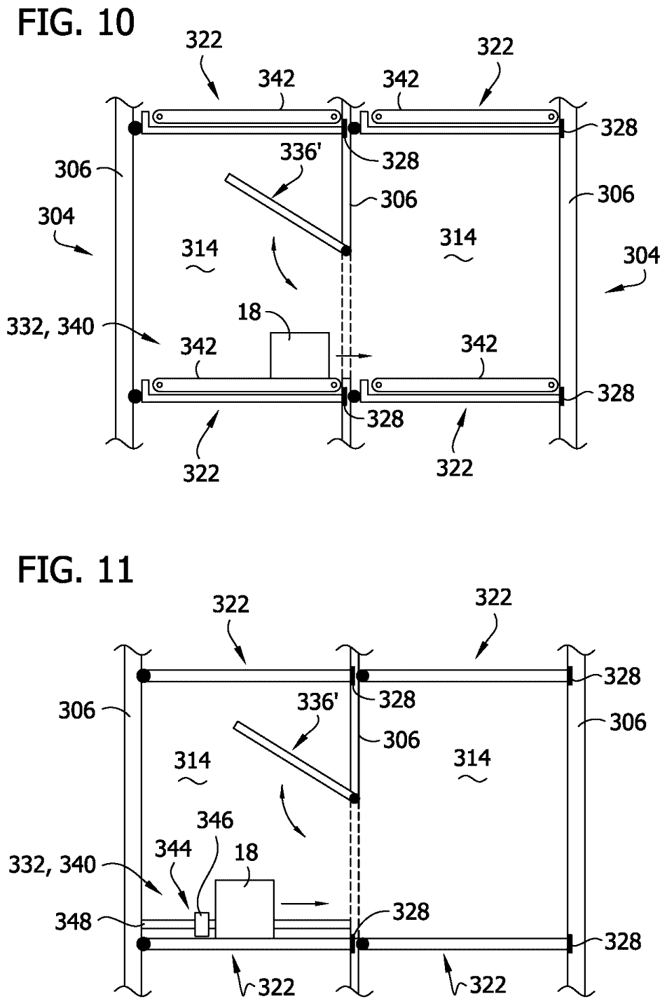

Referring to FIGS. 10 and 11, in other embodiments, the package mover 332 comprises an active package mover 340 that physically or mechanically moves the package 18 laterally. The active package mover 340 is configured to move the package 18 form the interior 314 of one locker compartment 304 of one locker bay 302 to the interior of a side-by-side locker compartment of another locker bay. In FIG. 10, the active package mover 340 comprises a conveyor 342 (e.g., an endless conveyor belt) built into the floor 322 of the locker compartment 304. The conveyor 342 is arranged to transport the package 18 toward the interior 314 of the other locker compartment 304. In this embodiment, the side wall section 336′ rotates or pivots about a hinge (broadly, pivot connection) located at the top of the side wall section. With the side wall section 336′ in the open position, the conveyor 340 moves the package 18 through the opening in the side wall 306. A conveyor 342 of the receiving locker compartment 304 may help move the package 18 through the opening in the side wall 306 and/or the side wall section 336′ may finish moving the package through the opening in the side wall as the side wall section returns to the closed position. The conveyors 342 may be reversible to change travel direction to move packages from one locker bay 302 to another or vice versa. Referring to FIG. 11, the active package mover 340 comprises a pusher 344 arranged to push the package 18 toward the interior 314 of the other locker compartment 304. In this embodiment, the pusher 344 comprises a swing or sweeper arm 346 that is moved from right-to-left (or vice versa) to push the package 18 into the interior 314 of the locker compartment 304 in the other locker bay 302. The arm 346 may be moved along a track 348 by a prime mover (not shown), such as a prime mover described herein. The pusher 344 may be able to push the package 18 completely into the other interior 314. For example, the track 348 may extend into the other interior 314. In one embodiment, each locker compartment 304 in a row includes a pusher, or there is one pusher for the entire row of locker compartments (e.g., one sweeper arm mounted on a track that extends along all the locker compartments of that row). Additionally, or alternatively, the side wall section 336′ may finish pushing the package into the other interior when moving to the closed position, as described above. Other types of active package movers can be used without departing from the scope of the present disclosure. The active package movers 340 can be implemented for each locker compartment 304 or only some of the locker compartments. As with the passive package movers 334, it is understood the floors 322 and the active package movers 340 can be operated in generally any sequence to move a package 18 to any desired locker compartment 304.

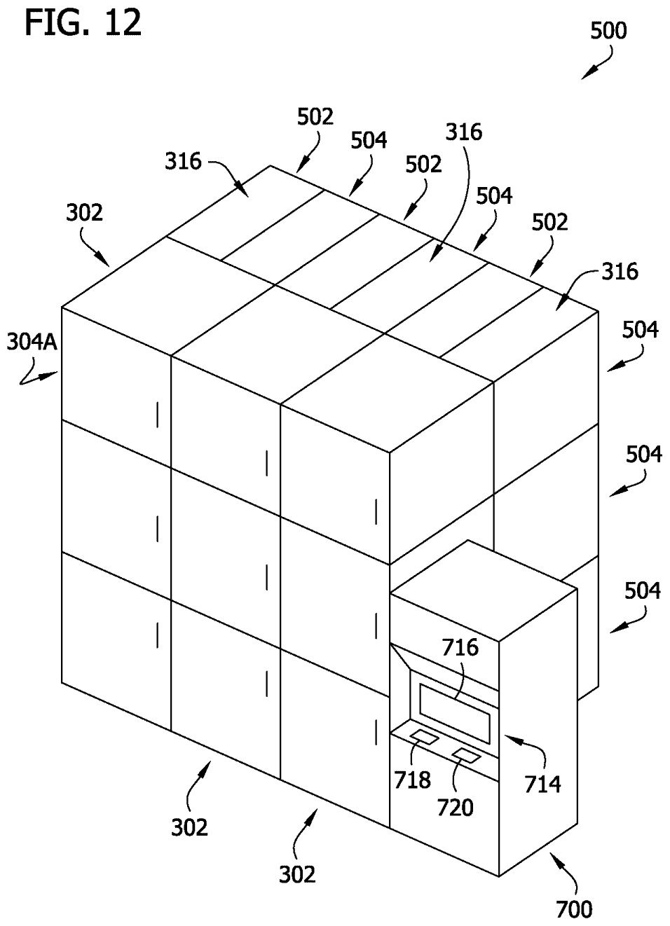

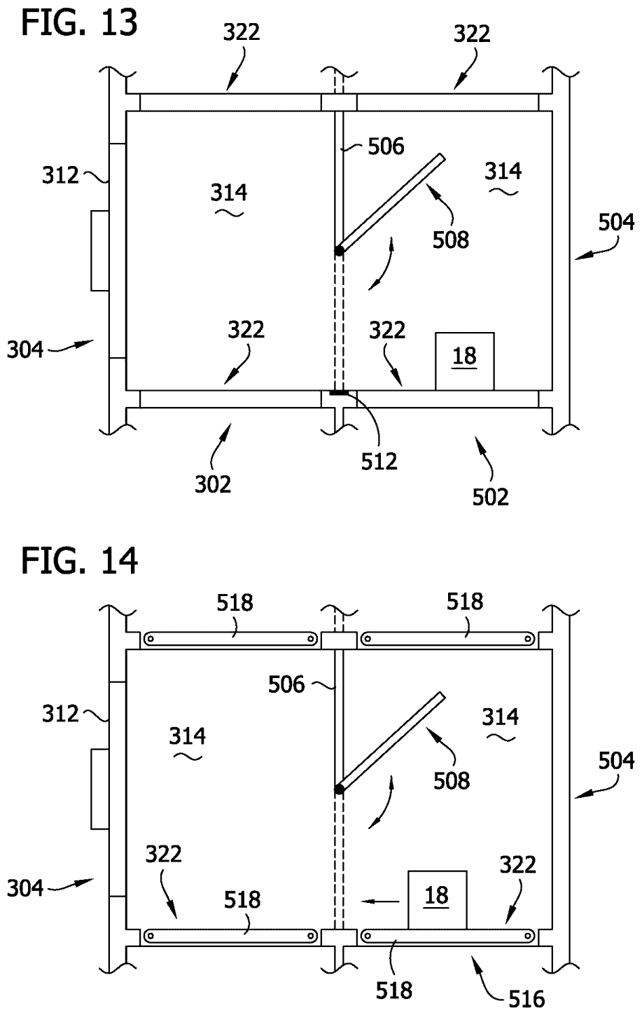

Referring to FIGS. 12 and 13, another embodiment of a package locker according to the present disclosure is generally indicated by reference numeral 500. The package locker 500 of FIGS. 12 and 13 is generally analogous to the package locker 400 of FIG. 8, and thus, for ease of comprehension, where similar, analogous or identical parts are used, identical reference numerals are employed. Accordingly, unless clearly stated or indicated otherwise, the above descriptions regarding the package locker 400 of FIG. 8 also apply to the package locker 500 of FIGS. 12 and 13.

In this embodiment, the package locker 500 includes three locker bays 302. The top locker compartment 304A of each locker bay 302 may or may not include a package entry door 316 (as illustrated, the top locker compartments do not include a package entry door). The package locker 500 includes a plurality of storage bays 502, with one storage bay for each locker bay 302. The storage bays 502 are generally identical to the locker bays 302. For example, the storage bays 502 includes a plurality of storage compartments 504, with each storage compartment corresponding to one of the locker compartments 304. The top storage compartments 504 include the package entry door 316. The storage compartments 504 also include the moveable floors 322, like the locker compartments 304. Moreover, the storage bays 502 can include the lateral package mover(s) 332 (e.g., the passive package mover 334, 334′ and/or active package mover 340) to move packages 18 laterally between interiors 314 of the storage compartments 504 (like as described herein with respect to moving packages laterally between the locker compartments 304). Accordingly, unless clearly stated or indicated otherwise, the descriptions herein regarding the locker bays 302 (and the components thereof) also apply to the storage bays 502 (and the components thereof). Accordingly, where similar, analogous or identical parts are used, identical reference numerals are employed.

Each storage compartment 504 is associated with one of the locker compartments 304 and is disposed rearward of the locker compartment. In particular, the storage compartments 504 abut up against the locker compartments 304. Instead of an access door 312 at the front of each storage compartment (and the rear wall of each locker compartment), the interiors 314 of the locker and storage compartments 304, 504 are separated by an intermediate or dividing wall 506. The dividing wall 506 selectively permits access or communication between the interiors 314 of the locker and storage compartments 304, 504. The dividing wall 506 includes a plurality of moveable dividing wall sections or panels 508 (broadly, moveable dividing walls) (similar to the side wall sections 336) which generally separate the front-to-back interiors 314 of the locker and storage compartments 304, 504. Each moveable dividing wall section 508 rotates or pivots about a hinge (broadly, pivot connection). In this embodiment, the hinge is located at the top of the dividing wall section 508. Each moveable dividing wall section 508 is arrangeable in a first or closed position or configuration where the dividing wall section separates the interiors 314 of the locker and storage compartments 304, 504 and in a second or open position or configuration where the dividing wall section permits a package to move through the dividing wall 506 (e.g., an opening in the dividing wall 506 vacated by the dividing wall section). In the open position, the dividing wall section 508 permits the package 18 to move from the interior 314 of the storage compartment 504 to the interior 314 of the locker compartment 304. In the open position, the dividing wall section 508 is disposed in the interior 314 of either the locker compartment 304 or the storage compartment.

In one embodiment, the dividing wall sections 508 are freely pivotable about their pivot connection. For example, when a recipient opens the access door 312 of the locker compartment 304, the user can then manually pivot the dividing wall section 508 to the open position to grab the package 18 in the interior 314 of the storage compartment 504 and remove the package from the package locker 500. In one embodiment, a releasable dividing wall latch or lock 512 (e.g., electronically operated latch or lock), as described herein, is provided for each dividing wall section 508. The dividing wall latch 512 is arranged to secure the dividing wall section 508 in the closed position, to inhibit the dividing wall section from inadvertently moving toward the open position. This provides extra security to prohibit unauthorized access of the packages. The dividing wall latch 512 will release the dividing wall section 508 to permit the dividing wall section to move toward the open position when the correct recipient accesses the locker compartment 304. For example, the dividing wall latch 512 can be unlocked at the same time the door latch 313 is unlocked or, alternatively, in response to the access door 312 being opened.

In one embodiment, each dividing wall section 508 is operatively connected to a prime mover 514 (e.g., a dividing wall section prime mover) (FIG. 16). The dividing wall section prime mover 514 moves its corresponding dividing wall section 508 between the open and closed positions. The dividing wall section prime mover 514 may comprise a motor (e.g., electric or pneumatic motor), linear actuator (e.g., electric or pneumatic linear actuator), or any other suitable device. The dividing wall section 508 can be moved to the open position by the dividing wall section prime mover 514 at the same time the door latch 313 is unlocked or, alternatively, in response to the access door 312 being opened. Similarly, the dividing wall section 508 can be moved to the closed position by the dividing wall section prime mover 514 in response to the access door 312 being closed and/or the package sensors 330 detecting the absence of a package in the interior 314 of the storage compartment 504. With the dividing wall section 508 in the open position, the recipient of the package 18 can reach through the dividing wall 506 (e.g., the opening vacated by the dividing walls section), grab the package 18 in the interior of the storage compartment 504 and remove the package from the package locker 500.

Referring to FIG. 14, in other embodiments the package locker 500 includes a package mover (broadly, one or more package movers), generally indicated at 516, to move the package 18 forwardly (and rearwardly), between the interior 314 of the storage compartment 504 and the interior 314 of the locker compartment 304. Accordingly, the package mover 516 may be considered as a front-to-back package mover. In general, the front-to-back package mover 516 can move a package 18 from the interior 314 of the storage compartment 504 to the interior 314 of the locker compartment 304 when the dividing wall section 508 is in the open position. The front-to-back package mover 516 is an active package mover. In FIG. 14, the front-to-back package mover 516 comprises a conveyor 518 (e.g., an endless conveyor belt) built into the floor 322 of the storage compartment 304. The conveyor 518 is arranged to transport the package 18 toward the interior 314 of the locker compartment 304. Thus, the conveyor 518 generally moves the package 18 forward. With the dividing wall section 508 in the open position, the conveyor 518 moves the package 18 through the opening in the dividing wall 506. In one embodiment (as illustrated), the front-to-back package mover 516 may also comprise a second conveyor 518 built into the floor 322 of the locker compartment to facilitate complete reception of the package in the interior 314 of the locker compartment 518. Additionally or alternatively, the dividing wall section 508 may finish moving the package 18 through the opening in the dividing wall 506 as the dividing wall section returns to the closed position. The transport direction of the conveyors 518 may also be reversed (e.g., rearward) if needed to move the package back to the storage compartment 504. In one embodiment, the conveyors 518 may be multi (e.g., quad) directional or omni-directional so that the conveyors can serve as both the front-to-back package mover 516 and the lateral package mover 332 (see FIG. 10). Other types of package movers may be used without departing from the scope of the present disclosure. For example, the front-to-back package mover 516 may comprise a pusher, similar to the pusher 344 (FIG. 11) arranged to push the package 18 toward the interior 314 of the locker compartment 304. The front-to-back package mover 516 can be implemented for each pair or set of locker and storage compartments 304, 504 or only some of the pairs.

In this embodiment, the interior 314 of the storage compartment 504 may be inaccessible to the recipient. Instead, the front-to-back package mover 516 moves the package 18 from the interior 314 of the storage compartment 504 to the interior 314 of the locker compartment 304 for the recipient to then remove from the locker compartment. Thus, in this embodiment, the storage compartments 504 simply provide storage of the packages 18 until the packages are ready to be retrieved. In one embodiment, the front-to-back package mover 516 moves the package to the locker compartment 304 before the door latch 313 is unlocked. In one example, the front-to-back package mover 516 moves the package 18 to the locker compartment 304 when the recipient is close (e.g., within a ¼ mile) of the package locker 500 (broadly, when the recipient is on the way to pick up the package), which can be determined via the mobile computing device 202 of the recipient.

As is apparent and understood by the person of ordinary skill in the art, the combination of the front-to-back package movers 516, the lateral package movers 332, and the moveable floors 322 (of both the locker and storage compartments 304, 504) enables the package locker 500 to be able to move a package 18 to generally any interior 314 (locker compartment 304 or storage compart 504) of the package locker (regardless of which top storage compartment 504 or top locker compartment 304A the package was delivered to by the UAV 10). The front-to-back package movers 516, the lateral package movers 332, and/or the moveable floors 322 can be operated in generally any sequence to move a package 18 to any desired locker/storage compartment 304, 504.

The storage compartments 504 provide several benefits to the package locker 500. First, the storage compartments 504 increase the number of packages that can be held and stored for the different recipients. Further, the storage compartments 504 provide an additional layer of security to prevent unauthorized access of the packages 18 contained within the package locker. For example, in one type of implementation, the package locker 500 may be installed in an exterior wall of a facility (e.g., a pharmacy), with the storage compartments 504 generally disposed on the inside of the facility and the locker compartments 304 disposed on the outside of the facility. This way, the locker compartments 304 are accessible to recipients without having to enter the facility, while the storage compartments 504 are safely contained in the facility. This may be particularly desirable where the facility uses the UAVs 10 to make internal deliveries within the facility (e.g., the UAVs fly within the facility). Further, if the UAVs 10 are coming from outside the facility (e.g., the UAVs fly through the UAV opening), this type of implementation allows the UAV's to deliver the packages 18 to the package locker 500 outside of elements (e.g., weather) of the outside environment.

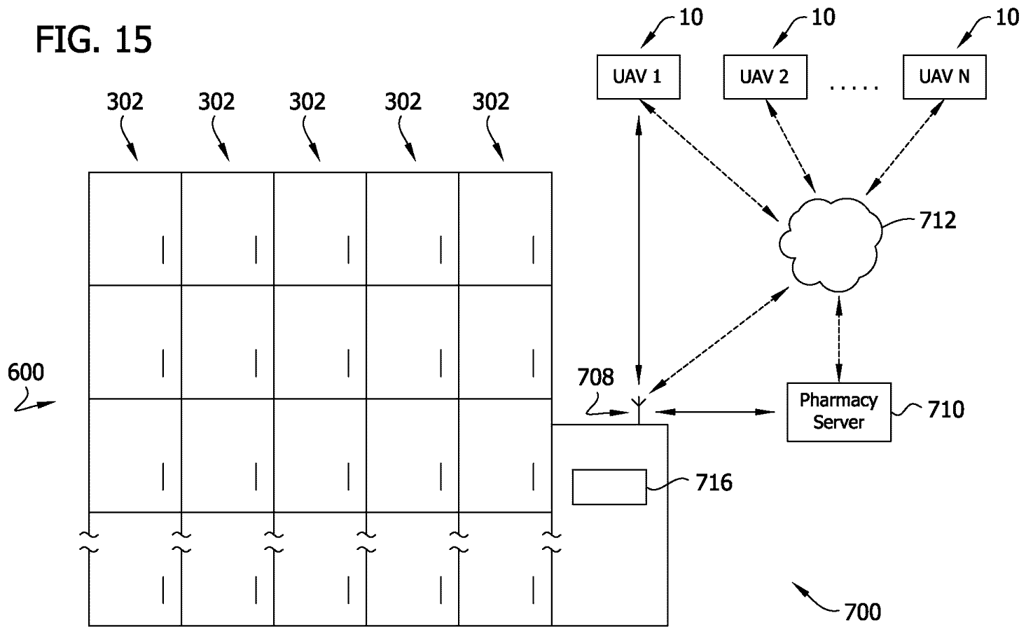

Referring to FIG. 15, another embodiment of a package locker according to the present disclosure is generally indicated by reference numeral 600. The package locker 600 of FIG. 15 is generally analogous to the package lockers described herein, and thus, for ease of comprehension, where similar, analogous or identical parts are used, identical reference numerals are employed. Accordingly, unless clearly stated or indicated otherwise, the above descriptions regarding the package lockers also apply to the package locker 600 of FIG. 15. In this embodiment, the package locker 600 includes five locker bays 302.

Referring to FIGS. 4, 12, 15, and 16, a control system 700 suitable for controlling the package lockers 300, 400, 500, 600 of the present disclosure will now be described. In general, the control system 700 controls and operates the package locker 300, 400, 500, 600. The control system 700 may also include or be part of the control device 100 (described above), can thereby perform the functions and actions of the control device described herein. For example, the control system 700 can control the UAVs 10 (like the control device 100). The control system 700 includes a controller 702 having a CPU or processor 704 and RAM or memory 706 (broadly, non-transitory computer-readable storage medium). The controller 702 provides the computing engine that drives the operation of the package locker 300, 400, 500, 600. Broadly, the memory 706 includes (e.g., stores) processor-executable instructions for controlling the operation of the processor 702. The instructions embody one or more functional aspects of the package locker 300, 400, 500, 600 and its components, with the processor 704 executing the instructions to perform said one or more functional aspects. Thus, the operations and functions of the package locker 300, 400, 500, 600 and its components as described herein can be stored as instructions in the memory 706.

The controller 702 is communicatively coupled to the various components of the package locker 300, 400, 500, 600, such as the various prime movers 318, 324, 338, 514, the active package movers 240, 516, the door locks 313, the latches 328, 512, and the package sensors 330. For example, the controller 702 can operate the floor prime movers 324, the side wall section prime movers 338, and/or the active package movers 340, 516 to move a package from one interior 314 to another interior. The control system 700 can include one or more communication ports 708 (e.g., network interface 112), such as wireless communication ports, to communicate with other devices such as the UAVs 10, a server 710 (e.g., pharmaceutical server), mobile computing device 202, etc. The one or more communication ports 708 can include an infrared (IR) port, a hardwire port, a Bluetooth port, a cellular port (e.g., cellular communications broadband network) and/or a Wi-Fi port, although it is understood that various other types of communication ports (e.g., near field communication) can be used without departing from the scope of the present disclosure. The controller 702 can communication directly with these devices or over a communications network 712 (e.g., cellular, satellite, etc.). In one embodiment, the controller 702 may communicate with the UAVs 10 through the server 710. Example communications between the control system 700 and the UAVs 10 are described above in relation to the control device 100. Additionally, the control system 700 can tell the UAVs 10 which top locker compartment 304A or top storage compartment 504 to deliver the package 18 to. For example, the control system 700 can determine which top locker compartment 304A or top storage compartment 504 is empty using the package sensors 330, select one top locker compartment 304A or top storage compartment 504 to have the package 18 delivered to, and send a signal to the UAV 10 indicating the selected top locker compartment 304A or top storage compartment 504 the package is to be delivered to. The control system 700 may include a satellite positioning sensor (not shown) to provide global positioning data for the package locker 300, 400, 500, 600, which can then be shared with the UAVs 10.

The control system 700 includes a user interface 714. The user interface 714 may include a display 716 (e.g., screen or touch screen), user input actuators 718 (e.g., buttons, keypad, etc.), and/or a payment reader 720 (e.g., credit card reader). The display 716 can present information to the recipient, the recipient can input information using the user input actuators 718, and the recipient can provide payment for the package 18 using the payment reader 720. The controller 702 may also use information provided by the recipient via the user interface 714. For example, the recipient may enter an order code or customer code (e.g., numeric, alpha, or alphanumeric code) via the user interface, the controller 702 may then unlock the door lock 313 of the access door 312 of the locker compartment 304 containing the particular package 18 associated with the order or customer code. Further, the display 716 may tell the recipient which access door 312 to open (broadly, which locker compartment 304 the package is to be retrieved from). In one embodiment, each door lock 313 includes a user interface (e.g., a keypad) which the recipient (e.g., authorized recipient) enters a code to unlock the door lock and open the access door 312. The code may be generated by the controller 702 (such as when the package is delivered to the package locker 300, 400, 500, 600) or by the server 710 (such as when the order for the package is placed) and can be provided to the recipient via any suitable means, such as via the mobile communication device 202. This way only the intended recipient of the package (e.g., the authorized recipient) has the code to access the appropriate locker compartment 304. The controller 702 assigns the code to the user interface of the door lock 313 corresponding to the package locker 304 the package 18 will be retrieved from. In addition, the controller 702 can provide the recipient, via any suitable means such as the mobile communication device 202, with the particular locker compartment 304 (e.g., no. 3) that their package can be retrieved from.

The control system 700 (e.g., controller 702) is also able to keep track of the packages 18 in the various compartments 304, 504 of the package locker 300, 400, 500, 600 and operates the floor prime movers 324, the side wall section prime movers 338, and/or the active package movers 340, 516 as needed to move packages between the various compartments, such as to create space to receive more packages from additional UAVs. In general, the controller 702 is configured (e.g., programmed) to determine if an interior 314 of a compartment 304, 504 is empty and, if the interior is empty, to control the necessary floor prime movers 324, side wall section prime movers 338, and/or the active package movers 340, 516 (broadly, some or at least a portion of these elements) to move the package from one interior to another. The controller 702 may determine an interior 314 is empty via the package sensors 330 and/or by keeping track of which interiors are supposed to have a package 18 in them (as the packages are received from the UAVs, moved through the different interiors, held in the different interiors, and are removed from the interiors by the recipient). By identifying which interiors 314 are empty, the controller 702 can then determine which floor prime movers 324, side wall section prime movers 338, and/or the active package movers 340, 516 to operate to move packages 18 to the empty interiors to create more space in the upper locker and/or storage compartments 304, 504 to receive additional packages from the UAVs 10.

Preferably, the controller 702 operates the floor prime movers 324 one at a time when dropping the package 18 downward. This way the fall of the package 18 at any one time is minimal and less likely to cause any damage to the contents of the package. Moreover, typically, the package 18 will side down the floor 322 as the floor is moved to the release position, further minimizing the distance the package will fall (e.g., fall less than that height of the interior 314).

In one embodiment, the controller 702 may use artificial intelligence techniques to determine when to move packages 18 (e.g., move a package from a storage compartment 504 to a locker compartment 304) and where to move packages (e.g., which locker compartment to move the package to). This can be based on historical hold times and pick up times by the recipient in the past and/or by similar recipients (e.g., recipients whose packages contain the same contents, such as patients who receive the same medication).

The following are illustrative, non-exhaustive examples of the control system 700 moving packages within a package locker 300, 400, 500, 600. Further, it is understood that the principles described in these examples can generally be applied across the package lockers 300, 400, 500, 600 (by aggregating and sequencing as necessary) to move packages 18 between generally any interiors 314 of the package lockers.

The control system 700 (e.g., controller circuitry 702) can track each package location in the locker system, unlock a door to provide access to the interior volume of a particular locker compartment when a person is verified to receive the package stored within the locker compartment. In the case of the packages containing regulated products, e.g., pharmaceuticals, control system 700 (e.g., controller circuitry 702) can sense and store data related to the individual picking up the package and report the acquisition of the package by the individual. This acquisition can be reported by the shipper, e.g., a pharmacy or a medical provider, via electronic or wireless communication.

### Example 1: Package Locker 300 (FIG. 4)

With reference to the package locker 300 of FIG. 4, a UAV 10 is ready to deliver a package 18 to the top locker compartment 304A. In this example, the top locker compartment 304A already includes a package 18 in the interior volume 314. The package sensor 330 senses the package in the interior 314 of the top locker compartment 304A. In response, the controller 702 determines if the second locker compartment 304B contains a package, such as via the package sensor 330 associated with the second locker compartment. In this case, the second locker compartment 304B does not include a package 18. The controller 702 then operates the floor prime mover 324 associated with the top locker compartment 304A to move the floor 322 of the top locker compartment 304A to the release position, thereby dropping the package 18 down to the second locker compartment 304B to create space for the new package being carried by the UAV 10. The controller 702 operates the floor prime mover 324 associated with the top locker compartment 304A to move the floor 322 of the top locker compartment 304A back to the support position. The controller 702 operates the package entry door prime mover 318 to move the package entry door 316 to the open position. The controller 702 may then tell the UAV 10 the package 18 can be dropped. The UAV 10 drops the package 18 into the top locker compartment 304A. After, the controller operates the package entry door prime mover 318 to move the package entry door 316 to the closed position. The new package 18 is now ready to be retrieved by the recipient.

### Example 2: Package Locker 400 (FIG. 8)

With reference to the package locker 400 of FIG. 8, the controller 702 determines a package 18 in the top locker compartment 304 of the first locker bay 302A needs to be moved to the third locker compartment 304C of the second locker bay 302B to create room to receive additional packages. The controller 702 may poll the package sensors 330 along possible routes between the top locker compartment 304 of the first locker bay 302A and the third locker compartment 304C of the second locker bay 302B (in this case only two routes exist: (1) the top locker compartment 304 of the first locker bay 302A>the second locker compartment 304 of the first locker bay>the third locker compartment 304C of the first locker bay>the third locker compartment 304C of the second locker bay 302B; or (2) the top locker compartment 304 of the first locker bay 302A>the second locker compartment 304B of the first locker bay>the second locker compartment 304B of the second locker bay>the third locker compartment 304C of the second locker bay 302B) to determine if a route is available to move the package along (e.g., are these locker compartments 304 empty such that a package can be moved through it). After identifying a route, in this case the route including the third locker compartment 304C of the first locker bay 302A, the controller 702 operates the necessary components to move the package. The controller 702 moves the floor 322 of the top locker compartment 304A of the first locker bay 302A (via the corresponding floor prime mover 324) to the release position to drop the package 18 into the second locker compartment 304B of the first locker bay; then moves the floor 322 of the second locker compartment 304B of the first locker bay and the side wall section 336C between the interiors 314 of the third locker compartments 304C to the ramp configuration so that the package slides down the ramp and into the third locker compartment 304C of the second locker bay 302B.

### Example 3: Package Locker 500 (FIGS. 12 and 14)

With reference to the package locker 500 of FIGS. 12 and 14 (e.g., a package locker with storage compartments 504 and front-to-back package movers 516), a UAV 10 is ready to deliver a package 18. The controller 702 tells the UAV 10 to deliver the package 18 to the top storage compartment 504 of the middle storage bay 502. The controller 702 moves the package entry door 316 of the top storage compartment 504 of the middle storage bay 502 (via the corresponding package entry door prime mover 318) to the open position. After, the UAV 10 drops the package 18 into the interior 314 of the top storage compartment 504 of the middle storage bay 502. The package locker 500 may store the package 18 in the top storage compartment 504 of the middle storage bay 502 for a period of time until the recipient is close or has arrived at the package locker. At this time, the package 18 needs to be moved forward into a locker compartment 304 to be able to retrieved by the user. In this example, the locker compartments 304 of the middle locker bay 302 each already contain a package 18. The controller determines that the second locker compartment 304 of the right end locker bay 302 is empty and that the path from the top storage compartment 504 of the middle storage bay 502 to the second locker compartment 304 of the right end locker bay 302 is open. The controller 702 then operates the necessary elements to move the package 18 from the top storage compartment 504 of the middle storage bay 502 to the second locker compartment 304 of the right end locker bay 302. In this example, the controller 702 moves the side wall section 336′ (between the middle and right end top storage compartments 504) to the open position (via the corresponding side wall section prime mover 338) and operates the active prime mover 340 to move the package into the interior 314 of the top storage compartment 504 of the right end storage bay 502. The controller 702 then move the floor 322 of the top storage compartment 504 of the right end storage bay 502 to the release position (via the corresponding floor prime mover 324) to drop the package 18 down into the interior 314 of the second storage compartment 504 of the right end storage bay 502. The controller 702 then moves the dividing wall section 508 (between the second storage and locker compartments 304, 504 of the right end bays 302, 502) to the open position (via the corresponding dividing wall section prime mover 514) and operates the front-to-back package mover 516 (associated with the second storage compartment 504 of the right end storage bay 502) to move the package from the interior 314 of the second storage compartment 504 of the right end storage bay 502 into the interior 314 of the second locker compartment 304 of the right end locker bay 302. The recipient can now retrieve the package 18 from the second locker compartment 304 of the right end locker bay 302.

Some of the illustrated examples show the package locker systems as having a regular polygon shape, e.g., with each column having an equal number of rows, it is within the scope of the present disclosure to have one or more locker compartments at least one level higher than the locker compartments to store and dispense the package. In an example, the locker system can have a pyramid shape with the peak compartment being configured to receive the package from the UAV but not dispense the package to a recipient. The peak compartment can distribute the package to another locker compartment below the peak compartment.

The packages as used herein can be medication containing packages, e.g., those filled by a pharmacy system, such as that described in U.S. Pat. Nos. 10,424,408 & 11,842,316; and U.S. Patent Publication Nos. US20230133785, publication date 4 May 2023; all of which are hereby incorporated by reference. The package locker system can track the location of the packages when the packages contain a medication or pharmaceutical. It is desired to accurately track the location of the package in the package locker system as dispensing the correct medication or pharmaceutical to the correct user is an important for delivery of the medication or pharmaceutical.

While some of the embodiments shown in the figure only show a single type of package movement within the package locker system, it will be understood that combining the types of movement into a single package locker system is within the scope of the present disclosure.

Although described in connection with an exemplary computing system environment, embodiments of the aspects of the disclosure are operational with numerous other general purpose or special purpose computing system environments or configurations, with dedicated electrical circuits running instructions for delivery of a package. The computing system environment is not intended to suggest any limitation as to the scope of use or functionality of any aspect of the disclosure. Moreover, the computing system environment should not be interpreted as having any dependency or requirement relating to any one or combination of components illustrated in the exemplary operating environment.

Embodiments of the aspects of the disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the disclosure.

Embodiments of the aspects of the disclosure may be implemented with processor-executable instructions. The processor-executable instructions may be organized into one or more processor-executable components or modules on a tangible processor readable storage medium. Aspects of the disclosure may be implemented with any number and organization of such components or modules. For example, aspects of the disclosure are not limited to the specific processor-executable instructions or the specific components or modules illustrated in the figures and described herein. Other embodiments of the aspects of the disclosure may include different processor-executable instructions or components having more or less functionality than illustrated and described herein.

The order of execution or performance of the operations in embodiments of the aspects of the disclosure illustrated and described herein is not essential, unless otherwise specified. That is, the operations may be performed in any order, unless otherwise specified, and embodiments of the aspects of the disclosure may include additional or fewer operations than those disclosed herein. For example, it is contemplated that executing or performing a particular operation before, contemporaneously with, or after another operation is within the scope of aspects of the disclosure.

It is apparent that the elements, features, and/or teachings set forth in each embodiment disclosed herein are not limited to the specific embodiment(s) the elements, features and/or teachings are described in. Accordingly, it is understood that the elements, features and/or teachings described in one embodiment may be applied to one or more of the other embodiments disclosed herein, even if said elements, features and/or teachings where not described herein as being a part of said one or more of the other embodiments.

The Title, Field, and Background are provided to help the reader quickly ascertain the nature of the technical disclosure. They are submitted with the understanding that they will not be used to interpret or limit the scope or meaning of the claims. They are provided to introduce a selection of concepts in simplified form that are further described in the Detailed Description. The Title, Field, and Background are not intended to identify key features or essential features of the claimed subject matter, nor is it intended to be used as an aid in determining the claimed subject matter.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the aspects of the disclosure are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the aspects of the disclosure by way of example and not by way of limitation. This description enables one skilled in the art to make and use the aspects of the disclosure, and describes several embodiments, adaptations, variations, alternatives and uses of the aspects of the disclosure, including what is presently believed to be the best mode of carrying out the aspects of the disclosure. Additionally, it is to be understood that the aspects of the disclosure is not limited in its application to the details of construction and the arrangement of components set forth in the description or illustrated in the drawings. The aspects of the disclosure are capable of other embodiments and of being practiced or carried out in various ways. Also, it will be understood that the phraseology and terminology used herein is for the purpose of description and should not be regarded as limiting.

Having described aspects of the disclosure in detail, it will be apparent that modifications and variations are possible without departing from the scope of aspects of the disclosure as defined in the appended claims. It is contemplated that various changes could be made in the above constructions, products, and methods without departing from the scope of aspects of the disclosure. In the preceding specification, various embodiments have been described with reference to the accompanying drawings. It will, however, be evident that various modifications and changes may be made thereto, and additional embodiments may be implemented, without departing from the broader scope of the aspects of the disclosure as set forth in the claims that follow. The specification and drawings are accordingly to be regarded in an illustrative rather than restrictive sense.

What is claimed is:

1. A package locker for receiving a medication package from a flying vehicle, comprising:
a locker bay including a first locker compartment and a second locker compartment, the first locker compartment overlying the second locker compartment, the first and second locker compartments each having an interior sized and shaped to hold a package, the first locker compartment including a floor, the floor being arrangeable in a first position where the floor is arranged to support the package in the interior of the first locker compartment and in a second position where the floor is arranged to permit the package to fall, under the influence of gravity, from the interior of the first locker compartment into the interior of the second locker compartment.

2. The package locker of claim 1, wherein the package locker includes a prime mover operatively connected to the floor and configured to move the floor between the first and second positions.

3. The package locker of claim 2, wherein the floor comprises a trap door arranged to pivot into the interior of the second locker compartment when the prime mover moves the floor toward the second position.

4. The package locker of claim 2, wherein the floor comprises first and second bomb-bay doors arranged to pivot into the interior of the second locker compartment when the prime mover moves the floor toward the second position.

5. The package locker of claim 2, wherein the floor comprises a roll-up door arranged to be rolled-up when the prime mover moves the floor toward the second position.

6. The package locker of claim 1, further comprising a releasable latch arranged to secure the floor in the first position.

7. The package locker of claim 1, further comprising a package sensor arranged to detect the presence of a package in the interior of the first package compartment.

8. The package locker of claim 1, wherein the first locker compartment includes a package entry door at a top of the interior of the first locker compartment, the package entry door being arrangeable in a closed position where package entry door inhibits access to the interior of the first locker compartment and in an open position where the package entry door is arranged to permit the package to fall, under the influence of gravity, into the interior of the first locker compartment.

9. The package locker of claim 8, wherein the package locker includes a prime mover operatively connected to the package entry door and configured to move the package entry door between the open and closed positions.

10. The package locker of claim 9, wherein the package entry door comprises first and second bomb-bay doors arranged to pivot upward when the prime mover moves the package entry door toward the open position.

11. The package locker of claim 1, wherein the floor is a first floor, and wherein the locker bay includes a third locker compartment underlying the second locker compartment, the third locker compartment having an interior sized and shaped to hold the package, the second locker compartment including a second floor, the second floor being arrangeable in a first position where the second floor is arranged to support the package in the interior of the second locker compartment and in a second position where the second floor is arranged to permit the package to fall, under the influence of gravity, from the interior of the second locker compartment into the interior of the third locker compartment.

12. The package locker of claim 2, further comprising a controller configured to determine if the interior of the second locker compartment is empty and, after said determination, to control the prime mover to move the floor to the second position to permit the package to fall into the interior of the second locker compartment.

13. A package locker comprising:
a first locker compartment having an interior sized and shaped to hold a package;
a second locker compartment underlying the first locker compartment, the second locker compartment having an interior sized and shaped to hold the package;
a third locker compartment having an interior sized and shaped to hold the package, the third locker compartment disposed side-by-side with the second locker compartment such that the interior of the third locker compartment is horizontally and vertically offset from the interior of the first locker compartment; and
a package mover configured to move the package from the interior of the first locker compartment to the interior of the third locker compartment.

14. The package locker of claim 13, wherein the package mover is a passive package mover configured to move the package under the influence of gravity from the interior of the first locker compartment to the interior of the third locker compartment.

15. The package locker of claim 14, wherein the package mover is configured to move the package from the interior of the first locker compartment to the interior of the third locker compartment solely under the influence of gravity.

16. The package locker of claim 13, wherein the package mover includes a moveable floor of the first locker compartment and a moveable side wall separating the interiors of the second and third locker compartments, the floor and the side wall being arrangeable in a ramp configuration where the floor overlaps the side wall such that the floor and side wall form a ramp along which the package can slide, under the influence of gravity, from the interior of the first locker compartment to the interior of the third locker compartment.

17. The package locker of claim 13, wherein the first locker compartment includes a floor, the floor being arrangeable in a first position where the floor is arranged to support the package in the interior of the first locker compartment and in a second position where the floor is arranged to permit the package to fall, under the influence of gravity, out of the interior of the first locker compartment, and wherein the package mover includes a moveable side wall arrangeable in a first position where the side wall separates the interiors of the second and third locker compartments and in a second position where the side wall is disposed in the interior of the second locker compartment and underlies the interior of the first locker compartment.

18. The package locker of claim 17, wherein the side wall is disposed at an angle to the horizontal in the second position such that the side wall forms a ramp along which the package can slide, under the influence of gravity, toward the interior of the third locker compartment after the package falls from the interior of the first locker compartment.

19. The package locker of claim 13, wherein the package mover comprises an active package mover configured to move the package from the interior of the second locker compartment to the interior of the third locker compartment.

20. The package locker of claim 19, wherein the active package mover comprises a pusher arranged to push the package toward the interior of the third locker compartment and/or a conveyor arranged to transport the package toward the interior of the third locker compartment.

21. The package locker of claim 13, further comprising a controller configured to determine if the interior of the third locker compartment is empty and, after said determination, to control the package mover to move the package from the interior of the first locker compartment to the interior of the third locker compartment.

22. A package locker comprising:
a locker compartment having an interior sized and shaped to hold a package, the locker compartment including an access door at the front of the locker compartment, the access door being moveable between a closed position where access door inhibits consumer access to the interior of the locker compartment and an open position where the access door permits consumer access to the interior of the locker compartment to allow a consumer to remove the package;
a storage compartment having an interior sized and shaped to hold the package, the storage compartment disposed rearward of the locker compartment; and
a dividing wall arrangeable in a first configuration where the dividing wall separates the interiors of the locker compartment and the storage compartment and in a second configuration where the dividing wall permits the package to move from the interior of the storage compartment to the interior of the locker compartment.

23. The package locker of claim 22, further comprising a package mover configured to move the package from the interior of the storage compartment to the interior of the locker compartment when the dividing wall is in the second configuration.

24. The package locker of claim 23, wherein the package mover comprises a pusher arranged to push the package toward the interior of the locker compartment and/or a conveyor arranged to transport the package toward the interior of the locker compartment.

25. The package locker of claim 22, wherein the locker compartment is a first locker compartment, the storage compartment is a first storage compartment, and the dividing wall is a first dividing wall, the package locker further comprising:
a second locker compartment having an interior sized and shaped to hold the package, the second locker compartment overlying the first locker compartment, the second locker compartment including an access door at the front of the second locker compartment, the access door of the second locker compartment being moveable between a closed position where access door of the second locker compartment inhibits consumer access to the interior of the second locker compartment and an open position where the access door of the second locker compartment permits consumer access to the interior of the second locker compartment to allow a consumer to remove the package, the second locker compartment including a locker compartment floor arrangeable in a first position where the locker compartment floor is arranged to support the package in the interior of the second locker compartment and in a second position where the locker compartment floor is arranged to permit the package to fall, under the influence of gravity, from the interior of the second locker compartment into the interior of the first locker compartment;
a second storage compartment having an interior sized and shaped to hold the package, the second storage compartment disposed rearward of the second locker compartment and overlying the first storage compartment, the second storage compartment including a storage compartment floor arrangeable in a first position where the storage compartment floor is arranged to support the package in the interior of the second storage compartment and in a second position where the storage compartment floor is arranged to permit the package to fall, under the influence of gravity, from the interior of the second storage compartment into the interior of the first storage compartment; and
a second dividing wall arrangeable in a first configuration where the second dividing wall separates the interiors of the second locker compartment and the second storage compartment and in a second configuration where the second dividing wall permits the package to move from the interior of the second storage compartment to the interior of the second locker compartment.

26. The package locker of claim 25, further comprising a first front-to-back package mover and a second front-to-back package mover, the first front-to-back package mover being configured to move the package from the interior of the first storage compartment to the interior of the first locker compartment when the first dividing wall is in the second configuration, and the second front-to-back second package mover being configured to move the package from the interior of the second storage compartment to the interior of the second locker compartment when the second dividing wall is in the second configuration.

27. The package locker of claim 25, further comprising:
a third locker compartment having an interior sized and shaped to hold the package, the third locker compartment disposed side-by-side with the first locker compartment such that the interior of the third locker compartment is horizontally and vertically offset from the interior of the second locker compartment, the third locker compartment including an access door at the front of the third locker compartment, the access door of the third locker compartment being moveable between a closed position where access door of the third locker compartment inhibits consumer access to the interior of the third locker compartment and an open position where the access door of the third locker compartment permits consumer access to the interior of the third locker compartment to allow a consumer to remove the package;
a third storage compartment having an interior sized and shaped to hold the package, the third storage compartment disposed rearward of the third locker compartment and side-by-side with the first storage compartment such that the interior of the third storage compartment is horizontally and vertically offset from the interior of the second storage compartment;
a third dividing wall arrangeable in a first configuration where the third dividing wall separates the interiors of the third locker compartment and the third storage compartment and in a second configuration where the third dividing wall permits the package to move from the interior of the third storage compartment to the interior of the third locker compartment;
a first side-to-side package mover configured to move the package from the interior of the second locker compartment to the interior of the third locker compartment; and
a second side-to-side package mover configured to move the package from the interior of the second storage compartment to the interior of the third storage compartment.

28. The package locker of claim 27, wherein the first side-to-side package mover includes the locker compartment floor of the second locker compartment and a first movable side wall separating the interiors of the first and third locker compartments, the locker compartment floor of the second locker compartment and the first movable side wall being arrangeable in a ramp configuration where the locker compartment floor of the second locker compartment overlaps the first side wall such that the locker compartment floor of the second locker compartment and the first side wall form a first ramp along which the package can slide, under the influence of gravity, from the interior of the second locker compartment to the interior of the third locker compartment; and
wherein the second side-to-side package mover includes the storage compartment floor of the second storage compartment and a second movable side wall separating the interiors of the first and third storage compartments, the storage compartment floor of the second locker compartment and the second movable side wall being arrangeable in a ramp configuration where the storage compartment floor of the second storage compartment overlaps the second side wall such that the storage compartment floor of the second storage compartment and the second side wall form a second ramp along which the package can slide, under the influence of gravity, from the interior of the second storage compartment to the interior of the third storage compartment.

29. The package locker of claim 27, wherein:
the first side-to-side package mover includes a first pusher arranged to push the package toward the interior of the third locker compartment and/or a first conveyor arranged to transport the package toward the interior of the third locker compartment; and
the second side-to-side package mover includes a second pusher arranged to push the package toward the interior of the third storage compartment and/or a second conveyor arranged to transport the package toward the interior of the third storage compartment.

30. The package locker of claim 27, further comprising a controller configured to determine if the interior of the third locker compartment is empty and, after said determination, to control some of the first front-to-back package mover, the second front-to-back package mover, the first side-to-side package mover, and the second side-to-side package mover to move the package from the interior of the second storage compartment to the interior of the third locker compartment.
